(19) United States
(12) Patent Application Publication
(10) Pub. No.: US 2011/0078949 A1
(43) Pub. Date: Apr. 7, 2011

(54) BREEDING AND REPRODUCTION SYSTEM FOR LIGHT-INTENSIVE MICROORGANISMS (SUCH AS ALGAE)

(75) Inventors: Juergen Schuster, Bad Emstal (DE); Horst Kurzweil, Leipzig (DE)

(73) Assignee: Alge Oil GmbH & Co. KG, Berlin (DE)

(21) Appl. No.: 12/960,877

(22) Filed: Dec. 6, 2010

Related U.S. Application Data
(63) Continuation of application No. PCT/EP2009/003966, filed on Jun. 3, 2009.

(30) Foreign Application Priority Data
Jun. 5, 2008 (DE) 10 2008 026 829.1

(51) Int. Cl. A01G 1/00

(52) U.S. Cl. 47/1.4

(57) ABSTRACT

The invention relates to a system for the breeding and reproduction of microorganisms, comprising a basin system (10) and a nutrient suspension (12) disposed in the basin system (10), wherein the basin system (10) comprises a vertical meandering system formed by partition walls (14) in order to achieve a substantially vertical flow of the nutrient suspension (12) in the basin system (10). The invention further relates to a method for the breeding and reproduction of microorganisms by means of a system in which light is introduced into a basin system (10) comprising a nutrient suspension (12), wherein the introduction of the light is carried out by way of partition walls (14) projecting into the nutrient suspension (12), said walls being filled with a dispersive liquid. In this manner an improved yield of microorganisms per hectare can be obtained.

### STATUS OF THE APPLICATION

This application claims priority to and is a continuation of PCT Application PCT/EP2009/003966, filed Jun. 3, 2009 and claims priority from German Patent Application 10 2008 026 829.1 filed on Jun. 5, 2008, both of which are herein incorporated by reference in their respective entireties.

### BACKGROUND OF THE INVENTION

The invention relates to a system for raising and reproduction of microorganisms and a corresponding method for it.

The breeding and reproduction of microorganisms, especially algae, usually takes place in an open flat basin, which has a height of about 30 cm.

Such a facility for the breeding and reproduction of algae is known from DE 23 58 701, which describes a nutrient suspension-filled flat basin in which there are partitions. These are arranged such that a horizontal meander wall is provided to achieve a horizontal flow path of a nutrient suspension within the flat basin. To achieve a flow of nutrient suspension within the shallow basin, a pump arrangement is provided which pumps the nutrient suspension around the shallow pool.

Due to the low height and depth of the flat basin and corresponding low volume utilization of the basin, the attainable yield per hectare of algae is low. It may also come to be that in a flat basin, due to the ratio of a large surface area to a relatively small volume of the pool or the nutrient suspension, the nutrient-suspension can undergo heating within the basin due to incident light radiation to a point where the incident radiation and heat is capable of harming developing microorganisms. The use of a pump assembly inside the flat basin to promote nutrient flow within the nutrient suspension can also result in the generation of relatively high pressure which can also cause damage microorganisms and lead to a reduction in the growth of sensitive microorganisms.

The object of the invention is therefore to provide a system and a corresponding method for breeding and reproduction of microorganisms wherein improved yield of microorganisms per hectare is achieved.

This object is achieved by systematic breeding and reproduction of microorganisms with the features as described by the invention disclosed herein and by a corresponding method with the features of said invention. Advantageous developments of the invention are set forth in the claims provided.

### SUMMARY OF THE INVENTION

The invention includes the technical teaching that the basin system has a partition allowing for the formation of a vertical meander flow system to achieve a substantially vertical flow of the nutrient suspension in the basin system. A vertical flow within the basin system makes it possible to avoid using a flat or deep basin. The depth of the basin system is preferably between 1.80 m and 2.20 m. By using a system having greater depth of the basin, and a longer vertical length of the basin system, the fungibility of the resulting microorganisms is greatly enhanced. The prior art describes the use of shallower basins then those achieved with the present inventive system, and hence an improved yield of microorganisms, especially algae per acre of used area, whereby a optimal capacity utilization of the basin system, is achieved. The substantially vertical flow of the nutrient suspension in the basin system also serves to make up for the reduction of breeding by microorganisms as they adjust to a particular, favorable climate, because overheating of the nutrient suspension can be avoided. Also obtained by the vertical flow, is a particularly good mixing of the nutrient suspension, which succeeds in encouraging the growth of microorganisms in the nutrient suspension.

An advantageous embodiment of the invention provides that the basin system has a plurality of adjacent side walls having pools, each pool has a dividing wall which forms the side walls of adjacent tanks and an over flow area for the nutrient suspension to from a reservoir for movement into the pool adjacent thereof. The pools are preferably U-shaped and have a width of about 2 m to 3 m, a height of about 1.80 m to 2.20 m and a length of about 0.2 m to 0.4 m. There are any number of pools can be arranged next to each other, so that preferably provides for a pool length of more than 100 m is easily implemented. The flow within the basin is mainly vertical to the basin shaped floor along the bottom walls. Only in the area between the basin shaped bottom and the lower edge of a partition in the overflow area of two adjacent basins, i.e., above the side walls of the pool, is the nutrient suspension on a horizontal flow. Due to the overflow areas, the nutrient suspension is in constant motion, so that no additional pumping power is required within the basin system to cause a flow or movement of the nutrient suspension within the system. The flow of movement within the basin system is conducted at a relatively low speed and without excessive pressure, as such the microorganisms are treated within the nutrient suspension very gently and damage to the microorganisms is avoided during their growth process.

A further advantageous embodiment of the invention provides that the basins are arranged in a ring. In the annular arrangement of the basins, the nutrient suspension of a basin can be directly routed to another basin stream without having to be routed via an additional recovery system from the last tank to the first basin. In addition, the basin system doubles fungibility, so that the yield can be increased. With the ring-shaped arrangement of the pool, a particularly high efficiency of the system is achieved.

Advantageously, a lift arrangement for introducing the nutrient suspension is provided in the basin system, so that the nutrient suspension from a reservoir is able to flow through the nutrient suspension lift arrangement located on a side wall of a first basin of the basin system into the basin system. The lift assembly can be configured in the form of a plate, lifting out of the basin system an arranged nutrient suspension reservoir, so that nutrient suspension from the reservoir travels over the side wall of the first basin and into the basin system. The nutrient suspension is introduced into the basin system by the reservoir through first tank and spills over a extended height wall or barrier located in the side wall. The spillover creates within the nutrient suspension in the basin system, a flow, which continues from the first reservoir up to the last tank out. By using a hoisting or lifting arrangement, it is possible to carry out the transfer of nutrient-suspension in the basin system without the application of pump-derived pressure. For example, without the use of a pump, flow is achieved so that that allows movement of the nutrient suspension but at a pressure that does not rupture the microorganisms. Thus the cell walls of the cultured microorganisms are treated very gently so they are not damaged in transit from one basin to another basin. The present invention foresees a lift bucket conveyor arrangement being utilized in this configuration to very effective in moving the nutrient suspension.

Preferably, according to another embodiment of the invention, the side wall between the elevator assembly and the first tank has an extended height baffle. The baffle provides for a higher wall between the lifter and the first tank. This is preferable because the nutrient suspension system is must be elevated to a sufficient height to provide suitable momentum to the entire flow system, since it lacks the use of flow generating pumps. Therefore, when flowing into the basin system, the side wall and a baffle are of a greater height to achieve a flow movement at a certain speed without the need for a pump assembly is required.

An alternative embodiment to the elevator arrangement provides that the nutrient suspension is introduced by a pump in the basin system. It can also be provided, that such a pump is provided in addition to the lift assembly, which the exact rate of flow of the nutrient suspension is adjustable. By means of the pump, it is also possible to not arrange the basins in a ring configuration. In that circumstance, the nutrient suspension flow will travel from the last tank via a flow channel back in the first tank.

According to another embodiment of the invention, the elevator arrangement is designed as a pipe connection between a recent pool and a first pool. In the connecting pipe a spiral screw feeder with a regular and/or variable speed driven by a motor is mounted. By means of a screw feeder which is built in the suspension solution, the nutrient suspension solution is moved from last tank through the connecting pipe into the first tank and thus a circular feed loop and flow pressure is generated in the first basin. This moves the nutrient suspension solution through the basin system in a sufficient amount required to maintain a constant flow of the nutrient suspension.

According to another feature of the invention, the walls are transparent or light permeable in areas. In the light-permeable areas, it is possible to have the partitions, which are preferably hollow, direct light, heat and energy towards the nutrient suspension, particularly in the nutrient-suspension in the basin floor. This is designed to improve photosynthesis and thus the growth of microorganisms in the nutrient suspension is increased. The partitions can be configured in as being transparent through its entire circumferential surface. The partitions or transparent areas may, for example, may be formed of any semi-translucent materials such as milk glass or transparent plastic. The partition walls can introduce heat into the nutrient-suspension, which can allow for convection currents to be generated within the nutrient stream along the length of the partition. This can cause eddy effects within the nutrient suspension, which can turn result in a very good mixing of the nutrient suspension can be achieved.

It is particularly preferred that the partitions have a dispersive liquid. The partitions are designed to be essentially hollow and filled with dispersive liquid. By means of dispersive liquid, it is possible to transmit light, heat and energy in a simple way to within the walls to direct that energy to the nutrient suspension and evenly distribute it. The dispersive liquid contains dispersive particles that act like a light refractor, reflector or focuser and thus are a particularly effective at directing the light into the nutrient suspension to achieve high efficiency. The dispersive liquid can be made of a transparent liquid such as water, which does not contain dissolved pigments. Because the walls are preferably filled completely with the dispersive liquid inside the walls, large amounts of fluid that react to temperature changes very slowly, making it possible to provide a nearly constant temperature and thus a nearly constant energy and heat transfer in the nutrient suspension is provided.

According to another advantageous embodiment, the partitions posses a tube arrangement by which the dispersive fluid can be passed and directed over the entire long side of the partition walls in the form of a flexible tube. The dispersive liquid is directed through the tubing at a certain speed to run evenly, so that a more homogeneous temperature of the basin system and nutrient suspension within the basin system is achieved.

Preferably, the partitions also possess an LED (Light Emitting Diode) arrangement, by which light energy and heat can be introduced into the nutrient suspension. The LED arrangement is preferably in the bottom of the walls in the area of the basin floor and is arranged so that even in this area of the basin system there is still enough light to be introduced into the nutrient suspension. The LED arrangement is characterized as being particularly long lived LED. Preferably, light emitting diodes with a power output of 100 W are used to achieve a higher waste heat. Instead of LEDs a common light source, like light bulbs, can be used.

Furthermore, the partitions have advantageously positioned light collector for focusing the sunlight. The light collector is preferably located at the top of the walls, outside the basin. The light collector is employed to collect and concentrate sunlight from the given area, and discharging it into the partitions. In this case, each partition in envisioned as having a separate light collector. This concentrated sunlight has a the ability to collect a high proportion of light energy and high heat, and extend the light gathering area beyond the walls of the nutrient suspension tank. This allows the transfer of energy and heat to the nutrient suspension, which provides in simple manner and at low cost, an increase in photosynthesis and thus the growth of microorganisms are improved. The light collector may take the form of optical devices, such as focusing lenses.

According to another embodiment having the partition walls, heating elements and/or cooling elements are included. As such, it is possible to effect temperature changes can in order to compensate as quickly as possible to maintain an optimal temperature distribution within the partitions and thus within the nutrient suspension. As such an optimal climate for growing the microorganisms can be created.

According to another embodiment of the invention it is possible to control the temperature of the suspension solution by locating heating and/or cooling elements in or on the pool walls and in or on the partition. The heating and cooling elements or both, can be directed to the interior of the pool, the pool walls or petition walls. It is equally possible, of course, for the heating and/or cooling elements to be arranged on the outside of the pool walls. This has the advantage that the heat carried by the pelvic walls must pass through the walls, resulting in a lower temperature and thus there is a gentler temperature gradient across the entire basin.

In particular, it is advantageous to provide the necessary heating and/or cooling energy to pass through the passing of the dispersion liquid to heat exchanger surfaces by means of pumps.

A further advantageous embodiment of the invention provides that the partitions are connected by a web. The web is at the upper end of the partitions above the nutrient suspension. The web is preferably hollow and possessing a bar shaped cross section, the interior of which is hollow and contains and disperses dispersive fluid from one partition to the next partition, so that a permanent replacement of dispersive liquid takes place. The dock allows heating elements and/or cooling elements to be arranged to help regulate the temperature in order to maintain the growth of microorganisms at optimum temperature. The web is preferably located above the basin system and can also serve as light collector of sunlight, which would be released on the individual partitions.

The invention also relates to a method for breeding and reproduction of microorganisms by using the above device, with further embodiments of the developed system in which light is introduced to a nutrient suspension containing basin system, and which takes place with the introduction of light into the nutrient suspension protruding wall for a dispersive liquid filled.

By means of dispersive liquid, it is possible that the rearing of microorganisms with the required light and heat necessary, as effectively as possible, in a simple way to bring in the nutrient suspension and evenly distribute it.

The dispersive liquid preferably contains dispersed particles, which act like light reflectors or collectors and thus cause a particularly effective contribution of the light into the nutrient suspension. The dispersive liquid may consist of water containing un-dissolved pigments. The partitions are preferably all filled with dispersive liquid, so that inside the walls, a large amount of fluid that reacts to temperature changes very slowly. This makes it possible, a nearly constant temperature and thus nearly constant energy and heat are transferred to the nutrient system.

To achieve the most homogeneous and easy way to adjust the temperature of the walls throughout their long side, it is preferably provided that the dispersive liquid is flowing through a tube in the partition walls.

In relation to the benefits of the method is also pointed full covering the inventive system for raising and reproduction of microorganisms is possible and envisioned.

### BRIEF DESCRIPTION OF THE DRAWINGS

The invention with reference to the accompanying drawings by way of preferred embodiments is explained.

FIG. 1 is a schematic illustration of a first embodiment of an inventive system for the breeding and reproduction of microorganisms;

FIG. 2 is a schematic illustration of a second embodiment of an inventive system for raising and reproduction of microorganisms;

FIG. 3 is a schematic representation of an embodiment of the invention partition;

FIG. 4 is a schematic representation of an embodiment of an inventive arrangement and basin FIG. 5 is a schematic illustration of a third exemplary embodiment of an inventive system for the raising and reproduction of microorganisms.

### DESCRIPTION OF ILLUSTRATIVE EXEMPLARY EMBODIMENTS

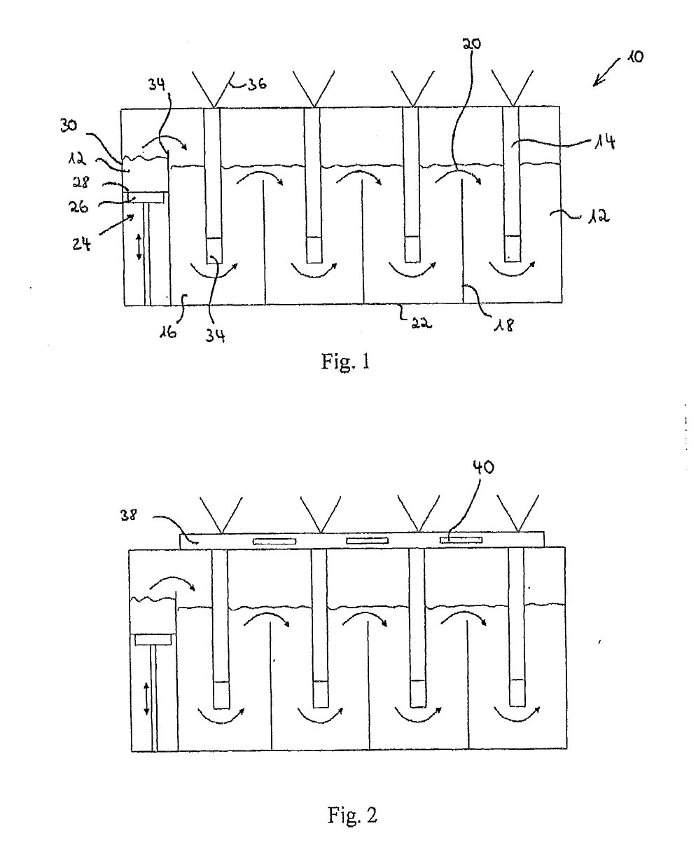

FIG. 1 shows a schematic representation of a first embodiment of an inventive system for breeding and reproduction shown by micro-organisms, with a basin system 10 that has arranged in the basin plant, a nutrient suspension 12, the basin system 10 is formed by partitions 14 of vertical meanders or baffle material configured to achieve substantially vertical flow of the nutrient suspension 12 in the basin system 10. The basin system 10 is composed of several adjacent, open, U-shaped basins or pools 16, in which is immersed in each basin 16, a vertical partition 14. Each tank 16 has side walls 18, the side walls 18 of adjacent basin 16 an over flow area 20, designed to allow the nutrient suspension 12 to travel from a basin 16 into an adjacent basin. Within the basin system 10, the nutrient suspension follows an essentially vertical flow path indicated by arrows in the area between a side wall 18 and a partition 14. In the overflow area 20 and in the area between the pool bottom 22 and the lower end of the partition 14, the flow, as shown by the arrows, is deflected, so that thereby a Vertical meander system formed.

To bring the nutrient suspension 12 into the basin system 10, a lift assembly 24 is provided. The lift assembly has a movable plate 26, through which the bottom plate 28 of a nutrient suspension reservoir 30 is upwardly moved, so that nutrient suspension 12 is directed over the edge of the reservoir 30 through the side wall 32 of a first tank 16 of the basin system 10 via spill the spillway. This arrangement ensures that the nutrient suspension 12 is introduced without pressure as gently as possible into the basin system 10 and is thereby achieved simultaneously within the basin system 10, a slight current. The side wall 18 between the reservoir 30 and the first reservoir 16 has a top 34, so that the height of the side wall 32 is configured higher than the level of the rest of the basin system 10 disposed sidewalls 18.

The partitions 14 are immersed in the pool at a central location of an individual basin 16. The partitions 14 have transparent areas through which light energy and heat can be introduced into the nutrient suspension. The translucent areas can be formed over the entire peripheral surface of the partitions 14. The partitions 14 and the transparent areas can, for example, be designed from milk glass or transparent plastic.

The partitions 14 are preferably configured as hollow structures. Within the walls is provided dispersive fluid, through which, in a simple manner, stored light energy and heat generated in partitions can be transmitted to the nutrient suspension 12. The dispersive liquid has particles that act like light collectors or reflectors and thus achieve a particularly effective contribution of the light in the nutrient suspension 12. The dispersive liquid may consist of water containing un-dissolved pigments. The partitions 14 are preferably filled completely by the dispersive liquid is inside the partition walls 14, a large amount of fluid that reacts to temperature changes very slowly. This makes it possible for a nearly constant temperature to be maintained and thereby provide nearly constant energy and heat transfer to the nutrient suspension 12.

The partitions 14 have an LED arrangement 34 which are preferably located at the lower end of the partitions 14. With the LED arrangements 34 additional light and warmth to the nutrient suspension 12 is introduced. Furthermore, the partitions 14, and light collector 36, are located in the upper part of the partition walls 14, and/or above the nutrient suspension 12 or the basin system 10. The light collector 36 are configured to collect and concentrate the incident sunlight and direct it into the partition walls 14 and arranged to direct their energy into the dispersive liquid, through which the heat and light of the sun is in turn released to the nutrient suspension 12 in the basin system 10.

The temperature within the walls 14 can be optimally adjusted, the partitions 14 may also (not shown here) have heating and/or cooling elements.

Heat introduced into in the nutrient suspension may, in the area along the dividing walls 14 and within the nutrient suspension 12, produce a thermal convection scheme, which may cause eddy effects within the nutrient suspension 12, are thus once again provides for a particularly good mixing of the nutrient suspension 12.

As shown in FIG. 2, the partitions 14 may be connected according to a second embodiment of the invention, disclosing a web 38, which is hollow and can optionally contain dispersive liquid. The web 38 can direct the dispersive liquid from one partition 14 to the next partition, so that a permanent replacement of fluid is currently is provided and the circulation of dispersive liquid is achieved. The web 38 may possess heaters and/or cooling elements 40 which may be arranged with the help of which one is set for the growth of microorganisms optimum temperature. Since the bridge 38 is preferably located above the basin system 10, it can serve as a light collector of sunlight, with the collected sun light emitted through the liquid to disperse the individual partitions 14.

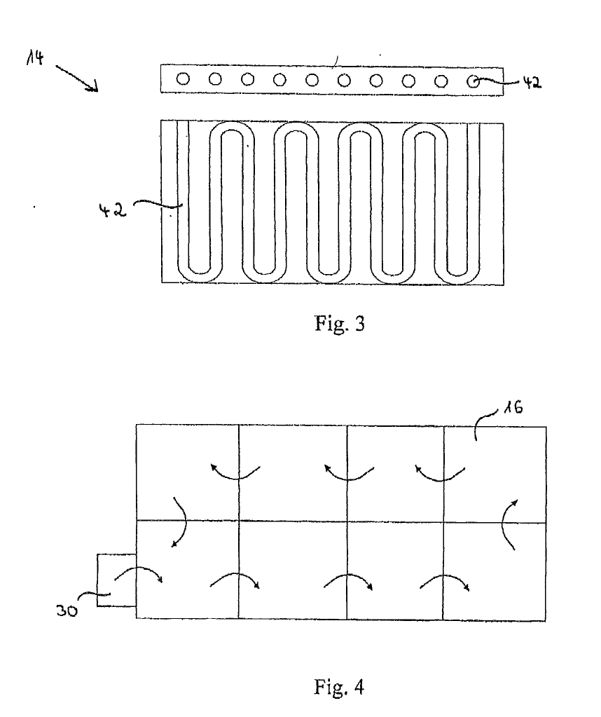

FIG. 3 shows schematically an embodiment of a partition 14 is shown having a tubing 42, through which the dispersive liquid inside the partition walls 14 can be performed so that a uniform temperature distribution along the partition wall is made, possible. The tubing 42 is preferably provided over the entire long side of the partition 14 disposed within the wall.

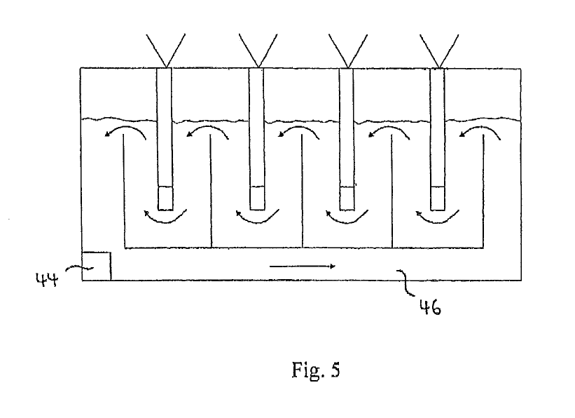

To enable easy and effective utilization of the basin system 10, the basin 16, as shown in FIG. 4, are arranged in a ring, so that the nutrient suspension 12 from directed from the last tank into the first tank and simply flows without the need of additionally physical pumps or other cumbersome mechanism for moving the suspension.

FIG. 5 shows a schematic representation of a third embodiment of an inventive system in which the nutrient suspension is introduced 12 by a pump 44 into the basin system 10. Underneath the individual pools, a flow channel 46 is arranged, which is fed by the nutrient suspension 12 in the individual basins 16. After the exit of the nutrient suspension 12 from the last tank, it will be again by the pump pumped through the flow channel 46 back into the first tank so that it creates a flow circuit of the nutrient suspension.

We claim:

1. A system for the breeding and reproduction of microorganisms, characterized as a basin configured to have at least one pool; and
a nutrient suspension medium (12);
at least one partially transparent partitions (14) delimiting a vertical flow path to direct the flow of the nutrient suspension medium;
wherein the partitions (14) are hollow and contain a dispersive liquid capable of directing and discharging electromagnetic energy into the nutrient suspension.

2. The system according to claim 1, characterized in that pool is characterized as possessing adjacent side walls (18), with each pool (16) having a partition (14) located within the pool and the side walls (18) of adjacent basins (16) forming an overflow area for the movement (20) of the nutrient suspension (12) from one pool the an adjacent pool.

3. The system according to claim 2, wherein at least one pool (16) is arranged in a ring.

4. The plant according to any of claims 1-3, characterized in that a lift arrangement (24) for introducing the nutrient suspension (12) into the basin system (10) is provided and further characterized in that a nutrient suspension reservoir is accessed by means of an elevator assembly located on the outside of a side wall of a first tank (16) of the basin system (10), and is configured to direct nutrient suspension medium into the basin system.

5. The system according to claim 4, wherein the side wall (32) between the elevator assembly (24) and the first reservoir (16) is an essay (34).

6. The system according to claim 4 or 5, wherein the lift arrangement is further characterized in possessing that a tube connecting a first reservoir (16), to a last pool of the basin system (10), through which can flow the nutrient suspension (12).

7. The System according to claim 6, wherein the connecting tube is a screw conveyor, which can be regulated and/or controlled by a motor.

8. The plant according to any of claims 1-3, wherein the nutrient suspension (12) is by means of a pump (44) located within the basin system (10) is introduced.

9. The system according to claim 1, wherein the partitions (14) possess a tube assembly (42), by which the dispersive fluid can be circulated between a plurality of partitions.

10. The plant according to claim 1, wherein the partitions (14) an LED array (34).

11. The plant according to claim 1, characterized in that the partitions (14) posses light collectors (36) for collection and concentration of sunlight.

12. Plant according to claim 1, wherein the partitions (16) possesses heating elements and/or cooling elements.

13. Plant according to claim 1, wherein the heating elements and/or cooling elements are arranged in or at the outside walls of the pool.

14. The system characterized according to claim 1, wherein in the basin, the heating and/or cooling elements are arranged outside the boundary walls.

15. Plant according to claims 1, wherein the partitions (16) via a web (38) are connected.

16. Method of rearing and reproduction of microorganisms by means of a system, wherein the light necessary to a nutrient suspension containing basin system is characterized in that the transfer of light into the nutrient suspension protruding partitions is that dispersive with a liquid-filled.

17. The method of claim 16, characterized in that the dispersive liquid has light directing particles.

18. The method of any one of claims 16-17, wherein the dispersive liquid flowing through a tube in the partition walls arranged arrangement.
